(19) United States
(12) Patent Application Publication
(10) Pub. No.: US 2017/0245464 A1
(43) Pub. Date: Aug. 31, 2017

(54) PET FEEDING BOWL

(71) Applicant: Xianpeng Chen, Taizhou (CN)

(72) Inventor: Xianpeng Chen, Taizhou (CN)

(73) Assignee: Taizhou Sunup Co. Ltd., Taizhou (CN)

(21) Appl. No.: 15/443,300

(22) Filed: Feb. 27, 2017

Related U.S. Application Data
(60) Provisional application No. 62/300,808, filed on Feb. 27, 2016.

(51) Int. Cl. A01K 5/01

(52) U.S. Cl. CPC A01K 5/0128; A01K 5/0121

(57) ABSTRACT

A pet feeding bowl may include a main body and an inner portion. In one embodiment, the main body is bowl-shaped with a receiving space. The main body also includes a holding portion at the bottom thereof. In an exemplary embodiment, the inner portion is also bowl-shaped with a receiving space. The inner portion is configured to dispose in the receiving space of the main body. The inner portion can be further secured at the main body when a predetermined amount of liquid is placed on a back side of the inner portion, so when the back side of the inner portion is in contact with the bottom portion of the receiving space, a surface tension will hold the inner portion to the receiving space to further secure it thereon.

### CROSS-REFERENCE TO RELATED APPLICATIONS

This application claims priority under 35 U.S.C. §119 (e) to U.S. Provisional Patent Application Ser. No. 62/300,808, filed on Feb. 27, 2016, the entire contents of which are hereby incorporated by reference.

### FIELD OF THE INVENTION

The present invention relates to a pet feeding bowl, and more particularly to a pet feeding bowl with a disposable bowl-shaped inner insert, so the pet owner can simply remove the inner insert instead of washing the pet feeding bowl every time when the pet finishes eating.

### BACKGROUND OF THE INVENTION

Feeding a domestic pet is usually done on the kitchen floor and usually results in the pet pushing some of its food out of the container and onto the kitchen floor partially due to the container being pushed along the floor as the pet tries to capture food particles from the sides of the container.

Many people dislike having to clean up the pet food spilled on the kitchen floor during feeding and in addition they dislike having to wash out the pet food container after feeding. Therefore, there remains a need for a new and improved design for a pet feeding bowl to overcome the problems presented above.

### SUMMARY OF THE INVENTION

It is an object of the present invention to provide a pet feeding bowl enclosing a disposable bowl-shaped inner insert so can simply remove the inner insert when the pet finishes eating.

It is another object of the present invention to provide a pet feeding bowl that the inner insert is made by edible materials.

It is a further object of the present invention to provide a pet feeding bowl that the inner insert is attached to the pet feeding bowl with a surface tension provided by a predetermined amount of liquid disposed between the inner insert and the pet feeding bowl.

In one aspect, a pet feeding bowl may include a main body and an inner portion. In one embodiment, the main body is bowl-shaped with a receiving space. The main body also includes a holding portion at a lower portion thereof.

In an exemplary embodiment, the inner portion is also bowl-shaped with a receiving space, and the food for the pet can be placed therein. The inner portion is configured to dispose in the receiving space of the main body. The inner portion can be further secured at the main body when a predetermined amount of liquid is placed on a back side of the inner portion, so when the back side of the inner portion is in contact with a bottom portion of the receiving space, a surface tension is generated to hold the inner portion to the receiving space to further secure it thereon.

When in use, the inner portion can be removed and thrown away after the pet finishes eating, so the main body does not have to be washed every time. A dent is formed on the top edge of the main body so the inner portion can be lifted up easily to overcome the surface tension between the main body and the inner portion. In one embodiment, the inner portion is plastic. In another embodiment, the inner portion is made by edible materials, so the owner of the pet does not to worry if the pet accidentally consumes the inner portion.

### BRIEF DESCRIPTION OF THE DRAWINGS

FIG. 1 illustrates a schematic view of the pet feeding bowl in the present invention.

FIG. 2 illustrates an exploded view of the pet feeding bowl in the present invention.

FIG. 3 illustrates a schematic view of an inner portion of the pet feeding bowl in the present invention.

FIG. 4 illustrates the back side of the inner portion of the pet feeding bowl in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

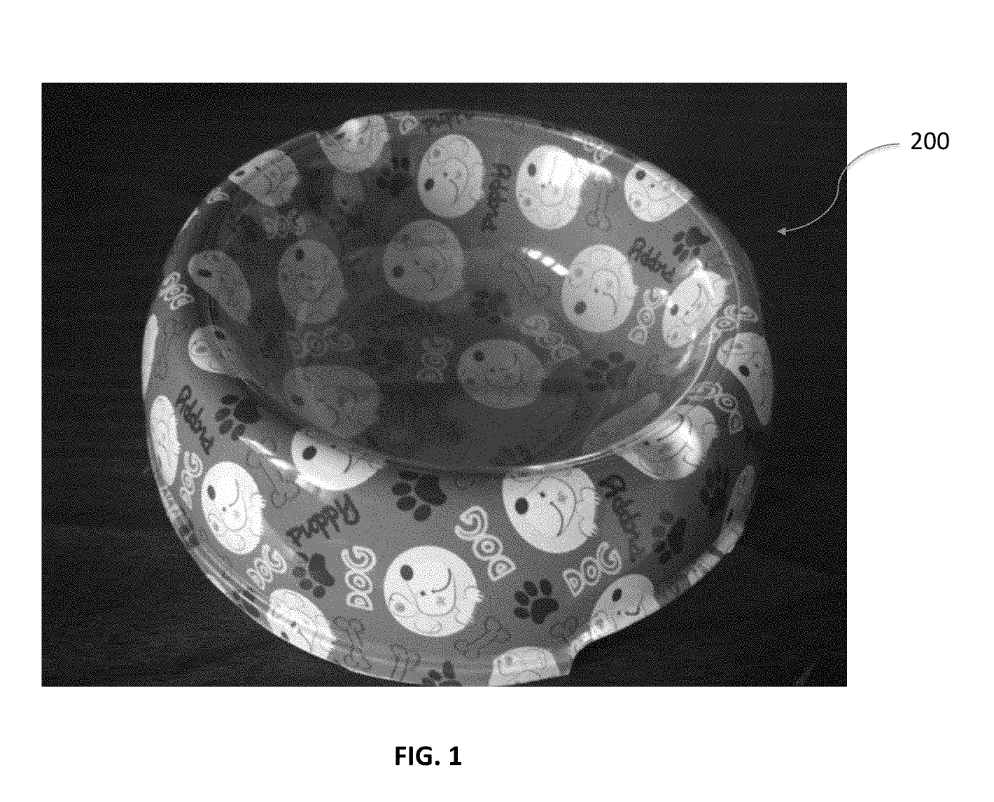

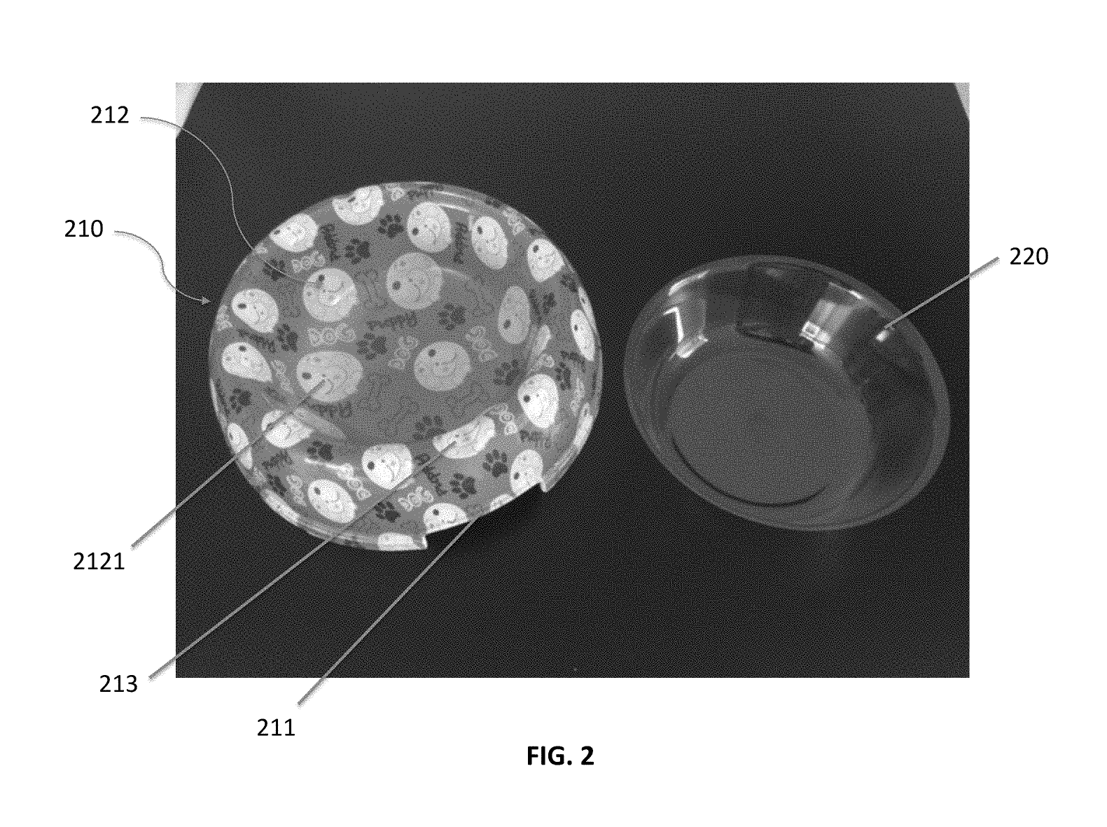

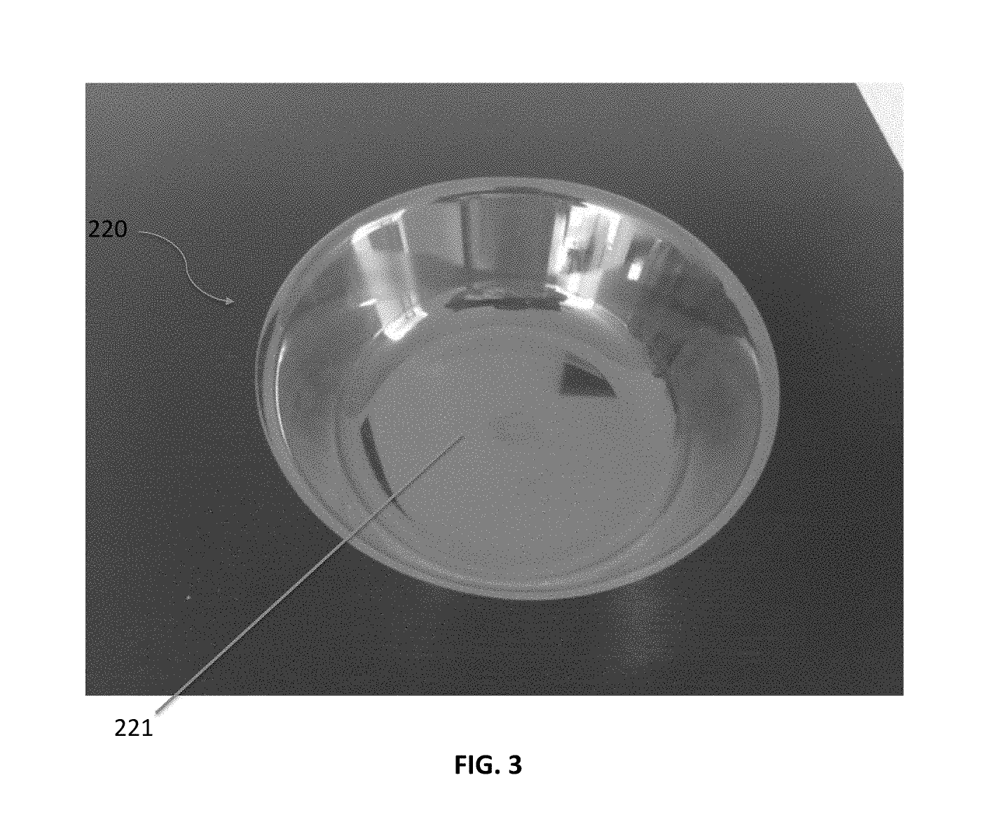

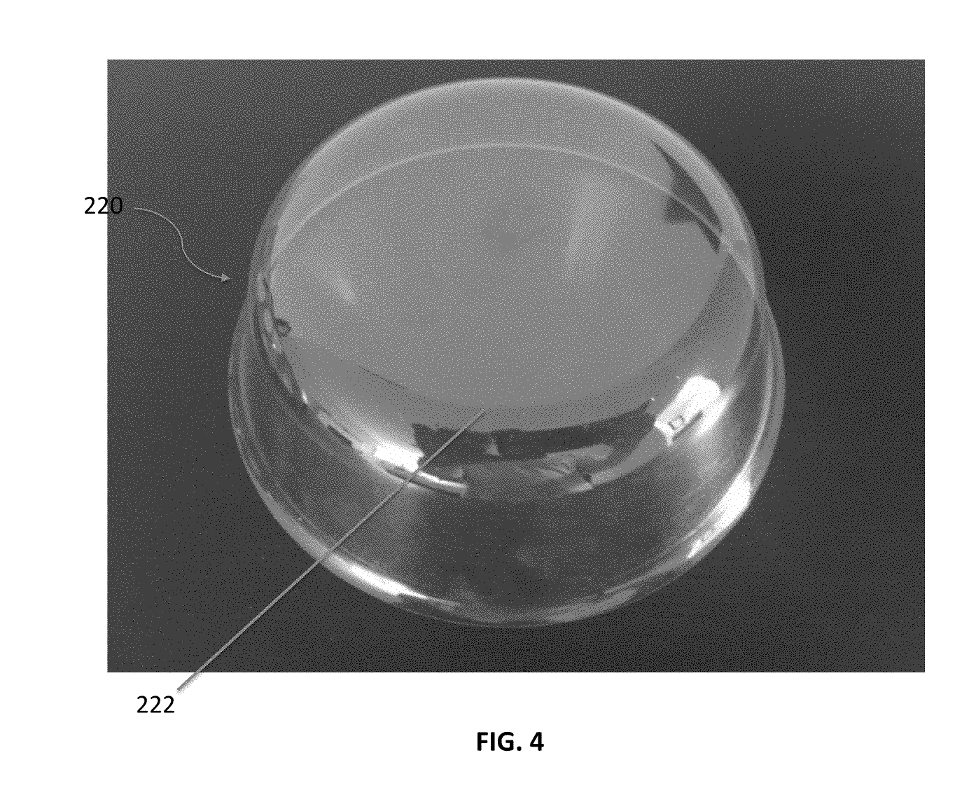

In one aspect, referring to FIGS. 1 to 4, a pet feeding bowl 200 may include a main body 210 and an inner portion 220. In one embodiment, the main body 210 is bowl-shaped with a receiving space 212. The main body 210 also includes a holding portion 211 at a lower edge of the main body 210.

In an exemplary embodiment, the inner portion 220 is also bowl-shaped with a receiving space 221, and the food for the pet can be placed therein. The inner portion 220 is configured to be smaller than the main body 210 and can be disposed in the receiving space 212 of the main body 210. The inner portion 220 can be further secured at the main body 210 when a predetermined amount of liquid is placed on a back side 222 of the inner portion 220, so when the back side 222 of the inner portion 220 is in contact with a bottom portion 2121 of the receiving space 212, a surface tension is generated to hold the inner portion 220 to the receiving space 212 to further secure it thereon.

When in use, the inner portion 220 can be removed and thrown away after the pet finishes eating, so the main body 210 does not have to be washed every time. A dent 213 is formed on the top edge of the main body 210 so the inner portion 220 can be lifted up easily to overcome the surface tension between the main body 210 and the inner portion 220. In one embodiment, the inner portion 220 is plastic. In another embodiment, the inner portion 220 is made by edible materials, so the owner of the pet does not to worry if the pet accidentally consumes the inner portion 220.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A pet feeding bowl comprising:
a bowl-shaped main body with a first receiving space; and
a bowl-shaped inner portion with a second receiving space,
wherein the inner portion is configured to be received in the receiving space of the main body, and a predetermined amount of liquid is placed on a back side of the inner portion, so when the back side of the inner portion is in contact with a bottom portion of the receiving space, a surface tension is generated to hold the inner portion to the receiving space to further secure it thereon.

2. The pet feeding bowl of claim 1, wherein the main body has a holding portion at a lower edge of the main body.

3. The pet feeding bowl of claim 1, wherein a dent is formed on the top edge of the main body so the inner portion can be lifted up easily to overcome the surface tension between the main body and the inner portion.

4. The pet feeding bowl of claim 3, wherein a dent is formed on the top edge of the main body so the inner portion can be lifted up easily to overcome the surface tension between the main body and the inner portion.

5. The pet feeding bowl of claim 1, wherein the inner portion is plastic.

6. The pet feeding bowl of claim 1, wherein the inner portion is made by edible materials, so the owner of the pet does not to worry if the pet accidentally consumes the inner portion.

7. The pet feeding bowl of claim 4, wherein the inner portion is made by edible materials, so the owner of the pet does not to worry if the pet accidentally consumes the inner portion.
